(19) United States
(12) Patent Application Publication
(10) Pub. No.: US 2008/0246584 A1
(43) Pub. Date: Oct. 9, 2008

(54) Locking digital pen

(76) Inventors: Kulvir Singh Bhogal, Forth Worth, TX (US); Gregory Jensen Boss, American Fork, TX (US); Rick Allen Hamilton, Charlottesville, VA (US); Alexandre Polozoff, Bloomington, IL (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 12/157,256

(22) Filed: Jun. 9, 2008

Related U.S. Application Data
(63) Continuation of application No. 11/197,618, filed on Aug. 4, 2005.

(51) Int. Cl. H04L 9/32

(52) U.S. Cl. 340/5.22

(57) ABSTRACT

A locking digital pen system includes memory means which is available for storing user passwords for a plurality of users. When a user wishes to activate the digital pen, the user is enabled to use the digital pen to enter a password. After verification of the password, the pen is unlocked and the system associates the user with a matching digital signature certificate. When the user wishes to lock the pen, the user is enabled to actuate a button on the pen or provide an entry to a coupled computer to initiate a locking sequence. The system then disassociates the user from the digital signature certificates so the pen can no longer be used to digitally sign documents and the pen enters a locked state. In another embodiment, an authorized user may disable the unlocking function of the pen whereby the pen may not be unlocked by entry of a password but rather only when a special code is entered into the system.

### FIELD OF THE INVENTION

The present invention relates generally to information processing systems and more particularly to a methodology and implementation for enabling a locking and unlocking of a digital pen.

### BACKGROUND OF THE INVENTION

Digital pens currently have the capability to associate a single user to a specific pen. However, in a shared environment, a pen currently lacks the functionality to distinguish between multiple users. To digitally sign handwritten documents, in contrast, it is necessary to associate an associated user to their digital certificate. Furthermore, in current art, the problem of potential pen theft has not yet been unaddressed. As digital pens are complex devices, they are generally expensive and attractive targets for theft.

Thus, there is a need for an improved methodology and system for enabling password protection to digital pens to prevent unauthorized personnel from using digital pens.

### SUMMARY OF THE INVENTION

A locking digital pen includes memory means for storing user passwords for a plurality of users. When a user wishes to activate the digital pen, the user is enabled to use the digital pen to enter a password. After verification of the password, the pen is unlocked and the system associates the user with a matching digital signature certificate. When the user wishes to lock the pen, the user is enabled to actuate a button on the pen to initiate a locking sequence. The system then disassociates the user from the digital signature certificates so the pen can no longer be used to digitally sign documents, and the pen enters a locked state. In another embodiment, an authorized user may disable the unlocking function of the pen whereby the pen may not be unlocked by entry of a password but rather only when a special code is entered into the system.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of a digital pen which is used in an one embodiment of the present invention;

FIG. 2 is an illustration of a pad computer system which may be used in conjunction with the digital pen shown in FIG. 1;

FIG. 3 is an illustration the pad computer system coupled to an interconnection network;

FIG. 4 is a block diagram illustrating several of the major components of the digital pen shown in FIG. 1;

FIG. 5 is a flow chart illustrating an unlock sequence used in an exemplary implementation of the present invention; and

FIG. 6 is a flow chart illustrating a lock sequence used in an exemplary implementation of the present invention;

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

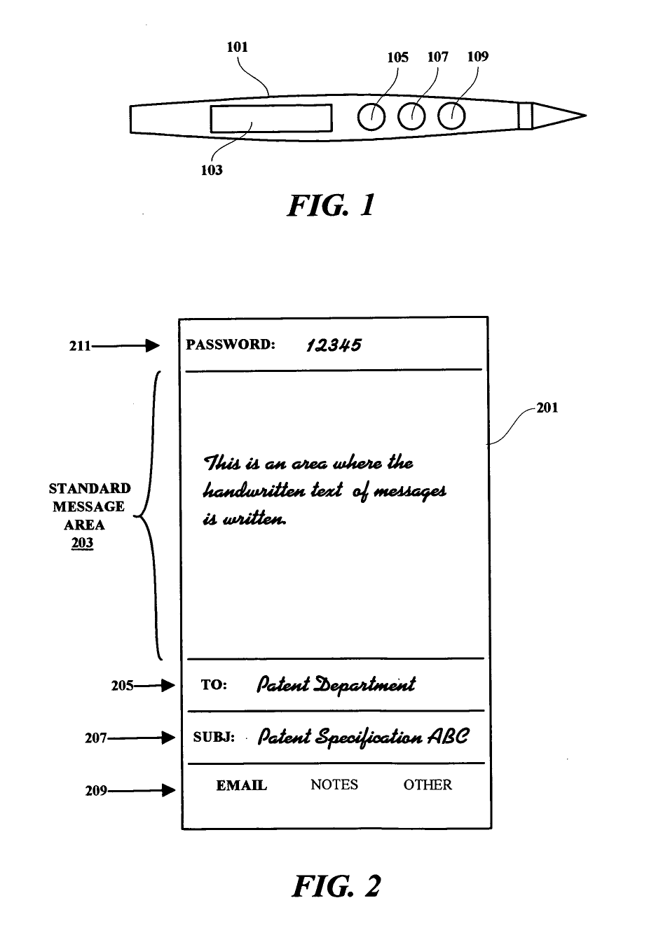

In FIG. 1, there is shown a digital pen 101 including a display area 103 for displaying information useful in operating the digital pen 101. The pen 101 also includes, in the example, a first selection button 105, a second selection button 107 and a third selection button 109. In the present example, the first button 105 may be programmed as an ON-OFF button for the digital pen 101. The second button 107 is used to toggle input and the third button 109 is used to lock the digital pen so that a password is required to unlock the pen. Other button switching devices or button functions, including tumbler switches which may be manually set to a selected combination of characters, may also be implemented to serve additional functions which may or may not be used in conjunction with the display 103. For example, in one embodiment, one input button is operable to toggle characters which are displayed on the pen display 103 and another button is used to enter the displayed character as one digit of a password or authorization code. When the entire password or authorization code has been input and displayed on the pen display 103, the user will then actuate another button which is effective to enter the displayed set or combination of characters as the password, and the system will then determine if the entered authorization code is on an approved listing of authorization codes, and if so, the digital pen is unlocked and assumes an enhanced operational mode. Thereafter, the authorized user may actuate another button to reset the pen to the limited operational mode which requires the entry of another password or authorization code. In this system, the pen may be used by any one of a listing of authorized users and each may have a different password or authorization code.

The locking methodology disclosed herein may be implemented with a digital pen that senses pressure, acceleration and other sensed changes in the pen tip as it is used for writing, or with a digital pen that operates in conjunction with a special pad or tablet as discussed in the example below. In the exemplary embodiment discussed below, a digital pen typically remains in a limited operational mode or locked state in which the pen is selectively operational to process input user passwords or authorization codes only. If an authorized password is entered, the pen assumes an enhanced operational mode in which the user of the pen is enabled to perform various enhanced functions, including but not limited to digitally signing electronic documents.

FIG. 2 shows an example of a writing tablet 201. The present invention may also be applied to digital pens which are designed for use with paper which is specifically designed for use with digital pens. The tablet 201 includes a standard message area 203 upon which comments may be hand-written using the digital pen 101. Also shown, in an exemplary email application, are input fields in which a user may input an addressee 205 of an email as well as a subject 207 for an email. An application area 209 enables a user to select one of several applications for the tablet system and a PASSWORD field 211 enables a user to input a password for use in locking and unlocking the digital pen 101.

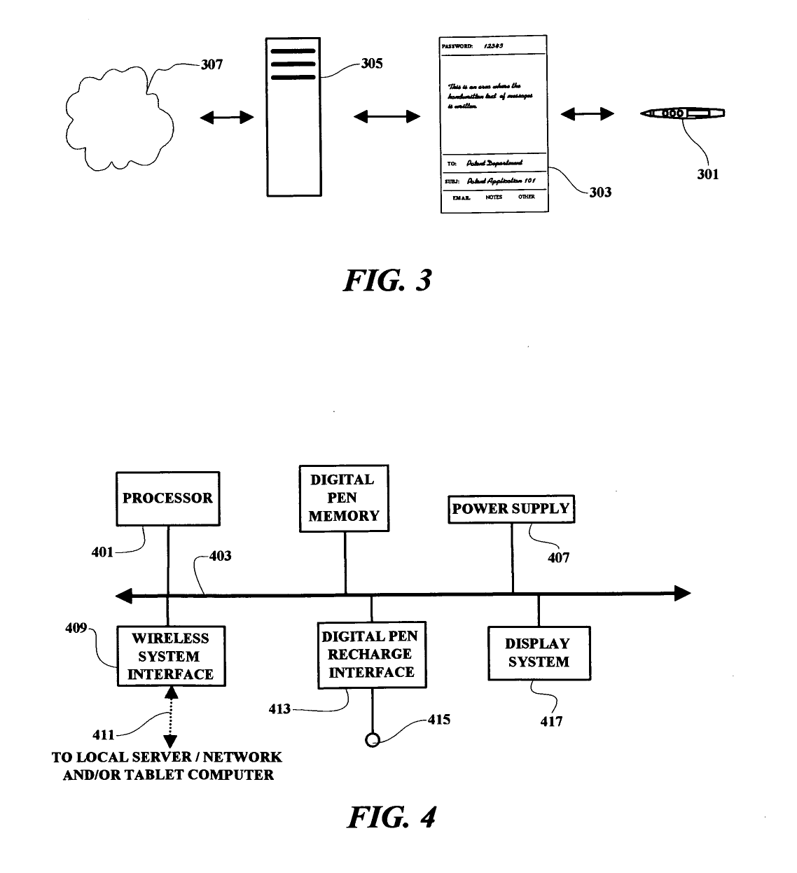

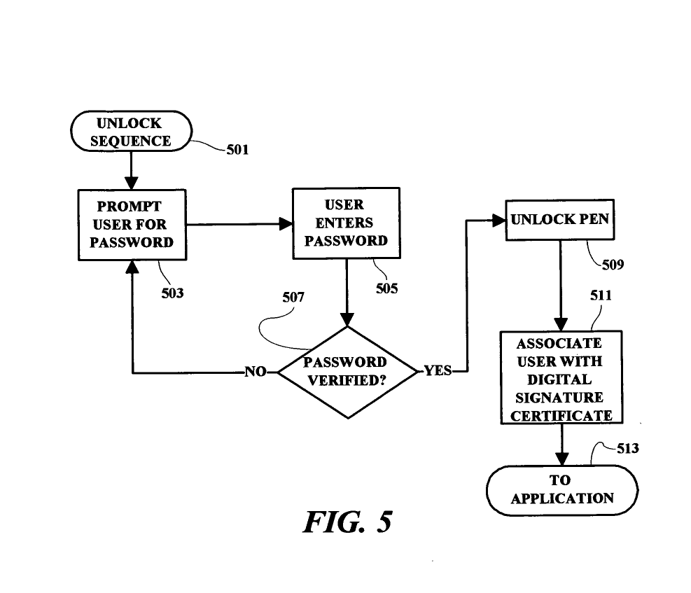

FIG. 3 illustrates a use of the tablet computer system in a network environment. The digital pen 301 is used to interface with the tablet computer 303 which, in turn, may be coupled to a server 305 with access to an interconnection network 307 such as the Internet, for communication with other computer systems connected to the network. The digital pen 301 is enabled to communicate with the tablet computer 303 through a wireless coupling or a hard-wired connection (not shown). For example, in the wireless example illustrated, the display area 103 on the digital pen 101 may be used to display a password which has been entered by a user into the system by writing the password in the appropriate field 211 of the tablet display.

FIG. 4 illustrates several of the major components of the digital pen system. In the illustrated example, the digital pen includes a processor 401 connected to a central bus 403. The bus 403 also connects to a memory 405 which is built into the digital pen, a power supply 407 which may comprise a replaceable or rechargeable battery or a hardwire connection to an external power supply if the digital pen application includes a cable connection to the tablet computer system. The digital pen memory may be used to store passwords which will unlock the pen, and other programmed functionality as is hereinafter discussed. A wireless system interface 409 is also shown for coupling 411 the digital pen 301 to the tablet computer system 303 and/or coupling the tablet computer to a server 305 for access to an interconnection network 307. If the power supply is a rechargeable supply, then the digital pen would also include a recharge interface 413 with a recharging terminal arrangement 415 to enable recharging of the power supply 407. The digital pen 101 also includes a display system 417 which is used in conjunction with the tablet computer 201 to control the display 103 of the digital pen 101.

The invention presented in this disclosure provides a system, method and apparatus for locking and unlocking a digital pen for multiple users. Once a user has unlocked a pen the user can do one of several things. Firstly, the public key associated with that user can be used for digitally signing or encrypting a document. Several users can be supported or multiple IDs for the same user can be supported. Secondly, a private key associated with a user can be used to encrypt documents. Thirdly, the pen itself can be disabled so that its function is useless without a password. This becomes a valuable anti-theft deterrent for expensive digital pens. Such a pen known to be unusable would have little or no resale value and present too high a risk for acquiring illicitly.

The user can lock a digital pen through the same methods as unlocking. The apparatus used is the digital pen itself and the means for locking and unlocking can occur in one of two methods. In one method, a password alone can lock or unlock the pen. This sequence of characters, symbols, and numbers would have to be unique so that it does not interfere with normal operation of the pen. In one embodiment, the lock and unlock passwords are unique. For example, if the password were commonly found in the language, problems would arise. For example, if a user chose the word “house” as the lock password, it is conceivable that he/she could inadvertently lock the pen when writing a sentence using the lock password. If however, the password were a combination of letters and numbers that would never be used in normal written communication, like “corv3tt3”, then this method becomes practical and requires no additional steps. In another embodiment, the same password is used to lock and unlock the pen, where the writing of the password merely signifies a binary state change for the pen.

In accordance with the present disclosure, there is provided a means for using password technology with digital pens. The mechanism that enables passwords to work within a digital pen includes adding a user interface (comprised of buttons and displays) and also a program product to the digital pen. This program product contains the logic to associate password management capabilities described above with specific unique functions of a digital pen.

A second method for locking/unlocking would involve incorporating a mechanical switch or button on the digital pen itself that signifies the user's desire to unlock the pen. When activated, this mechanism puts the pen into a lock or unlock verification state. In any embodiment related to UNLOCKing the digital pen, the user hand-writes a password somewhere on the page with metadata that identifies the password to use to unlock the digital pen. For example, the user writes: “UNLOCK 12345” on the paper. 12345 happens to be the password. This commands the pen to unlock itself without needing any buttons to push to put the pen into a mode of input to unlock the pen. In this method, several methodologies can be incorporated into verification processing. Techniques commonly used in forensics to identify the actual properties of the handwritten password can be analyzed, in addition to the representative characters. Since the signature can be evaluated at the time of creation, elements of handwriting which are normally not available for analysis are now possible, including changes in speed, pressure, and timing which may now be sensed and measured.

In a second UNLOCK embodiment, an input method and an LCD display are used to select a password, letter by letter and digit by digit to unlock the pen when the password is complete. By pressing a “SUBMIT” or “ENTER” button on the digital pen, the user completes the password.

In a third UNLOCK methodology, the a set of tumblers or thumbwheels (not shown) on the digital pen is used to input the password and when all the letters and digits of the password match up the pen is unlocked. Once the password is used to unlock the pen the user can change the tumblers to any random position.

When the digital pen is LOCKed, the pen can end up in two states. One is to lock the pen and completely disable all functionality, and the other state is to lock the pen but continue to allow the pen to function as it normally does except that the pen does not associate a digital signature with the user anymore so that no documents can be digitally signed. The state to disable the pen can either be configured to occur automatically on lock, or with a special lock code entered into the pen.

In another LOCK embodiment, the user handwrites the word LOCK with metadata that tells the pen this is a legitimate lock command. In another example, the word “LOCK” can be written within squared brackets “[ . . . ]” and the containment within the squared brackets would indicate a command that the pen should be locked rather than the input of text.

In another LOCK embodiment, the user simply presses a button on the digital pen that locks the pen. In another example, the user is enabled to enter a special sequence on a set of tumblers that locks the pen. In yet another LOCKing implementation, the user enters a special LOCK sequence through a selector on the LCD panel letter by letter or digit by digit that is selectively operable to lock the pen.

An exemplary UNLOCK sequence is illustrated in FIG. 3. As shown, the UNLOCK sequence 301 initially prompts the user for a password 303 and the user enters the password through any of the above described methodologies. If the entered password cannot be verified 307, the user is again prompted to enter the password 303. Once the password is verified 307, the digital pen is unlocked 309 and the system associates 311 the user with the digital signature certificate on file for the user's entered password and the tablet computer system executes the selected application 513 as indicated 209 in FIG. 2.

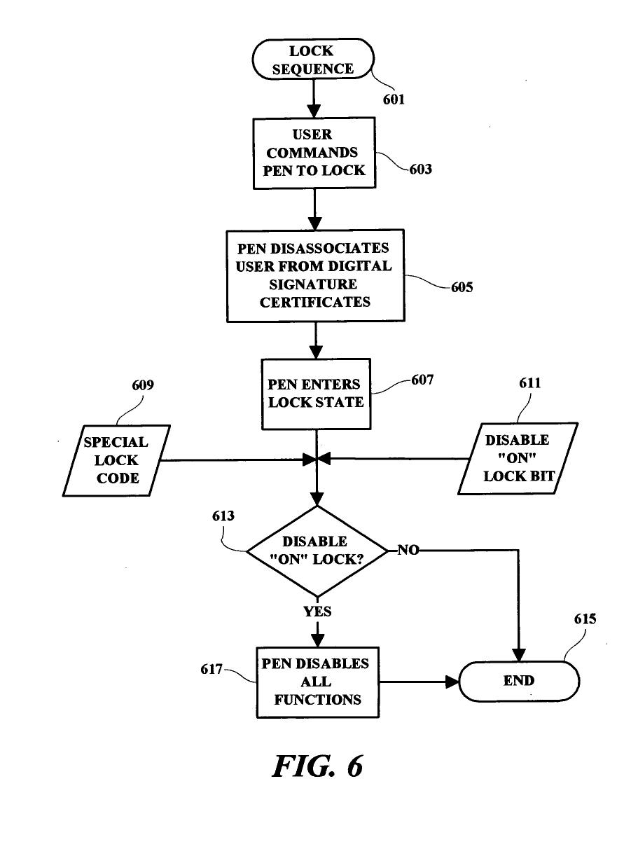

In an exemplary LOCK sequence 601 as shown in FIG. 6, a user commands 603 the digital pen to LOCK by any of the methodologies described above such as by writing the word LOCK on the tablet display or by pressing a LOCK button on the digital pen or by touching a PEN LOCK icon (not shown) on the tablet display. The pen then disassociates the user from the applicable digital signature certificate 605 and the pen enters a LOCK state 607 which will require the entry of another password to initiate the UNLOCK sequence. After entering the LOCK state, the user may also enter a special LOCK code 609 by any of the methods described above, to access a DISABLE ON LOCK BIT function 611. If the LOCK ON bit is not disabled by the user, the pen will remain in the LOCKed state thereby allowing other users to subsequently enter a password and use the pen. If the ON lock bit is disabled 613, the digital pen will disable all functionality of the pen 617 and the process ends 615. Thereafter, the user can bring the pen out of the disable mode by setting tumbler switches (not shown) to a “secret” number or by any of many other personal security-checking methods including but not limited to voice commands, finger-print scanning and retinal scanning.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented partially in program code stored on a CD, disk or diskette (portable or fixed), or other memory device, from which it may be loaded into memory and executed to achieve the beneficial results as described herein. Accordingly, the present invention is not intended to be limited to the specific form set forth herein. On the contrary, it is intended to cover such alternatives, modifications, and equivalents, as can be reasonably included within the spirit and scope of the invention.

What is claimed is:

1. A method for enabling usage of a digital pen by only authorized users to perform a set of enhanced functions in an enhanced operational mode, said method comprising:
using said digital pen in a limited operational mode, said limited operational mode being effective only to enable a first user of said digital pen to generate a user authorization code for said digital pen;
determining that said user authorization code generated by said first user is one of a plurality of predetermined authorization codes designated to enable use of said digital pen in said enhanced operational mode; and
enabling said enhanced operational mode with said digital pen if said first user authorization code is one of a plurality of predetermined authorization codes designated to enable use of said digital pen, said enhanced operational mode being operable to enable said user to use said digital pen to perform operations by said user with said digital pen which are not available to said user when said digital pen is in said limited operational mode.

2. The method as set forth in claim 1 and further including enabling said first user to change from said enhanced operational mode for said digital pen to said limited operational mode whereby a new authorization code may be generated by a second user to enable said enhanced function mode of said digital pen for said second user.

3. The method as set forth in claim 1 and further including enabling said first user to input said user authorization code directly into a user input device which is a part of said digital pen.

4. The method as said forth in claim 3 wherein said input device comprises a series of switching devices mounted on said digital pen, said switching devices being selectively operable by said first user for inputting said user authorization code.

5. the method as set forth in claim 4 wherein said series of switching devices comprises a series of tumbler switches, each of said tumbler switches being capable of being set by said first user to selected characters, said user authorization code being comprised of a combination of said selected characters.

6. The method as set forth in claim 4 wherein one of said switching devices is selectively operable to effect a change from said enhanced operational mode for said digital pen to said limited operational mode whereby a new authorization code may be generated by a second user to enable said enhanced function mode of said digital pen for said second user.

7. The method as set forth in claim 4 and further including displaying said user authorization code generated by said first user on a display device on said digital pen.

8. The method as set forth in claim 7 and further including using said display device on said digital pen to display information other than said user authorization code to said first user.

9. The method as set forth in claim 7 wherein said display device comprises a liquid crystal display.

10. The method as set forth in claim 3 and further including processing said user authorization code in processing means included within said digital pen to accomplish said determining.

11. The method as set forth in claim 3 and further including processing said user authorization code in processing means located remotely from said digital pen to accomplish said determining.

12. The method as set forth in claim 4 and further including storing said user authorization code in memory contained within said digital pen.

13. The method as set forth in claim 4 wherein said enabling said first user to change from said enhanced operational mode for said digital pen to said limited operational mode is accomplished by actuation of only one of said switching devices.

14. The method as set forth in claim 1 and further including, after said determining, associating said user authorization code with stored user certificate information in order to enable said first user to generate an authorized user digital signature for use in processing electronic commercial and other documentation.

15. A programmed product, said programmed product being executable by a computer system to generate operational signals effective for enabling said computer system to interface with a digital pen and allow usage of said digital pen by only authorized users to perform a set of enhanced functions in an enhanced operational mode, said operational signals being selectively operable to enable:
using said digital pen in a limited operational mode, said limited operational mode being effective only to enable a first user of said digital pen to generate a user authorization code for said digital pen;
determining that said user authorization code generated by said first user is one of a plurality of predetermined authorization codes designated to enable use of said digital pen in said enhanced operational mode; and
executing said enhanced operational mode with said digital pen if said first user authorization code is one of a plurality of predetermined authorization codes designated to enable use of said digital pen, said enhanced operational mode being operable to enable said user to use said digital pen to perform operations by said user with said digital pen which are not available to said user when said digital pen is in said limited operational mode.

16. The programmed product as set forth in claim 15 wherein said operational signals are further effective for:
enabling said first user to change from said enhanced operational mode for said digital pen to said limited operational mode whereby a new authorization code may be generated by a second user to enable said enhanced function mode of said digital pen for said second user.

17. A digital pen comprising:
user input means on said digital pen, said user input means being arranged for enabling usage of a digital pen by only authorized users to perform a set of enhanced functions in an enhanced operational mode, said user input means being selectively operable in a limited operational mode to enable a first user of said digital pen to generate a user authorization code for said digital pen;
memory means for storing said user authorization code;
means arranged for coupling said digital pen to a processing means, said processing means being selectively operable for determining that said user authorization code generated by said first user is one of a plurality of predetermined authorization codes designated to enable use of said digital pen in said enhanced operational mode, said processing means being further operable for enabling said enhanced operational mode with said digital pen if said first user authorization code is one of a plurality of predetermined authorization codes designated to enable use of said digital pen, said enhanced operational mode being operable to enable said user to use said digital pen to perform operations by said user with said digital pen which are not available to said user when said digital pen is in said limited operational mode.

18. The digital pen as set forth in claim 17 and further including means for enabling said first user to change from said enhanced operational mode for said digital pen to said limited operational mode whereby a new authorization code may be generated by a second user to enable said enhanced function mode of said digital pen for said second user.

19. The digital pen as set forth in claim 18 and further including a first switching means on said digital pen wherein said means for enabling said first user to change from said enhanced operational mode for said digital pen to said limited operational mode is accomplished by a single actuation of said first switching means.

20. The digital pen as set forth in claim 17 wherein said digital pen further includes a display device and a second switching means on said digital pen, said display device being selectively operable for displaying said authorization code generated by said first user to said first user, said second switching means being selectively operable by said first user to enter said authorization code displayed on said display device for said processing by said processing means.
